(19) United States
(12) Patent Application Publication
(10) Pub. No.: US 2024/0002668 A1
(43) Pub. Date: Jan. 4, 2024

(54) CORK DERIVED PRODUCT

(71) Applicant: DSIGNTANK, SL, Barcelona (ES)

(72) Inventor: Jokin ARREGUI LETAMENDI, Barcelona (ES)

(73) Assignee: DSIGNTANK, SL, Barcelona (ES)

(21) Appl. No.: 18/265,139

(22) PCT Filed: Sep. 27, 2021
(86) PCT No.: PCT/EP2021/076486

§ 371 Date: Jun. 2, 2023

(30) Foreign Application Priority Data
Dec. 3, 2020 (ES) U202032625

(51) Int. Cl. C08L 97/00; C08K 3/04; B65D 39/00

(52) U.S. Cl. CPC C08L 97/007; C08K 3/04; B65D 39/0058

(57) ABSTRACT

A cork derived product formed by a bonded mass of granulated and/or microgranulated cork particles and activated carbon particles mixed with the cork particles; wherein the cork particles and the activated carbon particles are bonded together by means of a binder; and the cork derived product includes the activated carbon particles in a proportion between 10% and 40% of the dry weight of the product, giving the cork derived product a darkened color.

### FIELD OF THE ART

The present invention relates to a cork derived product, specifically a cork derived product including a bonded mixture of granulated and/or microgranulated cork particles with activated carbon particles, forming an aggregated cluster that is impermeable to liquids and has a very low permeability to gases.

This cork derived product is particularly indicated for use in contact with food, cosmetic, and perfume products, for example, forming a stopper for a container, although other uses are not ruled out.

### STATE OF THE ART

Cork derived products formed from granulated and/or microgranulated cork particles are well known in the industry. They are typically obtained through a process of binding cork by means of mixing granulated and/or microgranulated cork with a binding additive which undergoes polymerization after the mixture is subjected to pressure and temperature in a mold or by means of an extrusion process, producing the bonded mass of granulated and/or microgranulated cork particles. As a result of the pressure applied during manufacture, cork particles are in close contact with one another, closing the spaces between them, and the resulting cork derived product has a very low porosity, which makes it impermeable to liquids and rather impermeable to gases.

Binding additives which are mixed with the cork are typically a prepolymer, usually a prepolymer containing isocyanate. After the application of moisture, pressure, and temperature during the molding or extrusion process, said prepolymer undergoes polymerization and is transformed into inert inorganic matter that is no longer reactive and acts as a cork particle binder, producing a bonded cork derived product.

The use of a cork derived product like the one described as a stopper of a container is extremely well known, particularly for closing bottles containing alcoholic beverages such as wine or sparkling wine, for example.

Like most natural and plant-based products, it is known that a certain percentage of cork derived products, such as cork stoppers, may cause a sensory defect in products that come into contact with same, specifically as a result of the presence of organochlorine chemical compounds (such as tri-, tetra-, and pentachlorophenols and anisoles) which, when released, ruin the aroma and flavor of the products with which they come into contact, a problem that is usually called cork taint. These compounds are the waste generated by the disappearance of a fungus existing previously in the cork when it reacts with certain compounds, typically chlorinated phenolic compounds used as antimicrobial agents in the treatment of wood-derived products.

Document ES2412529B1 discloses a cork derived product like the one described forming a stopper of a container, and furthermore includes an activated carbon insert within a cork stopper. Said activated carbon insert allows absorbing part of the oxygen trapped inside a container covered by said stopper, improving the preservation of any food product stored inside said container.

Document ES1240069U describes a similar solution, but in which the activated carbon is formed in the shape of a disk adhered to one of the ends of the cork stopper.

The present invention proposes a solution for improving the inherent properties of cork, improving its preservation properties when it is used in a stopper, and mitigating the problem of cork taint, among other advantages.

### BRIEF DESCRIPTION OF THE INVENTION

The present invention relates to a cork derived product.

As is known, said cork derived product is formed by a composition comprising a bonded mass of granulated and/or microgranulated cork particles bonded together by means of a binder.

However, in a manner that is unknown, it is proposed for this bonded mass to furthermore include activated carbon particles mixed with the cork particles.

The inclusion of activated carbon particles, mixed among the cork particles, can reduce the generation or the release of the compounds responsible for “cork taint”, reducing or eliminating said problem, which may represent a mere nuisance for a user or which, when the product is in contact with food products, may damage the organoleptic properties of said food products. In contact with other products such as cosmetic products, for example, said compounds can interact with said cosmetic products and alter their properties.

The absorbent and filtration properties of activated carbon can retain the compounds which trigger the generation of organochlorine compounds responsible for cork taint, or can retain organochlorine compounds once they are generated, preventing them from being released from the cork derived product. Furthermore, given that the activated carbon particles are mixed with the cork particles before the bonding thereof to form the cork derived product, the activated carbon will absorb any of these or other unwanted substances present in the cork particles before bonding, producing a cork derived product with said unwanted substances trapped in the activated carbon particles, preventing their subsequent release.

Furthermore, activated carbon has known filtration properties, so the resulting product will also have filtration properties, particularly with respect to a gas permeating through said product, or with respect to any substance or product that comes into contact with the mentioned cork derived product.

Another known problem of cork is that, in the presence of certain products, particularly products with dissolving power, such as alcohol from spirit beverages with a high alcohol content, perfumes, cosmetics, or other products, the solvent can extract color from the cork and stain said product to a certain proportion, which is particularly undesirable in clear beverages such as gin, vodka, or tequila, in cosmetic creams, or in perfumery. The activated carbon particles can absorb or filter the solvent in contact with the cork, preventing color from being extracted from the cork.

Activated carbon also provides a characteristic black color to any product containing it, so it allows the users to readily identify a cork derived product with improved properties such as the proposed product as a result of its color.

Activated carbon is also known for its purification properties for topical or digestive use when it is ingested, so the use thereof in a cork derived product that comes into contact with food or cosmetic products is even beneficial if small amounts of activated carbon are given off during use, for example, when activated carbon is included at high concentrations making it more probable for small amounts of the said activated carbon to be given off.

Preferably, the activated carbon particles will be or include microparticles or nanoparticles. It is understood that nanoparticles are particles of any shape with dimensions in the range comprised between 1×10⁻⁹ m and 1×10⁻⁷ m, and microparticles are particles of any shape with dimensions in the range comprised between 1×10⁻⁷ m and 1×10⁻⁴ m.

The smaller the size of the activated carbon particles is, the larger their effective surface, and therefore the better their filtration capacity will be. Despite the foregoing, it is contemplated that the activated carbon particles can also include larger size particles, for example, of up to mm in diameter, which can be mixed together with the cork particles and are immediately visible. Therefore, the carbon particles can have a size comprised between 0.5 micra and 5 mm.

The granulated cork or microgranulated particles can preferably have a size comprised between 0.2 mm and 10 mm.

Preferably, the binder of the cork derived product will be a polyisocyanate. However, the use of other binders for consolidating the cork particles is also known. For example, latex or certain adhesives may also be used as binders.

It is also proposed for the binder to include a proportion of activated carbon particles that is sufficient to give the cork derived product a darkened color with a mean color brightness value substantially less than the mean color brightness value of an equivalent product lacking activated carbon, facilitating the unequivocal identification thereof by a user. A user could therefore identify a container provided with a cork stopper providing all the aforementioned advantages.

It is understood that a substantially less mean color brightness value will be at least 10% or at least 15% less than the mean color brightness value of an equivalent cork derived product that, however, lacks carbon particles.

Preferably, the darkened color of the cork derived product will have a mean color brightness value equal to or less than 50% or preferably equal to or less than 40%, whereas an equivalent product without activated carbon typically has a mean color brightness value equal to or greater than 70%.

It is understood that color brightness is the capacity of a color to reflect the white light striking it, with the colors having a brightness value closest to 0% being the darkest.

According to a preferred embodiment, said cork derived product will be a stopper of a container or part of a stopper of a container.

The mentioned cork derived product will preferably form at least one part of the stopper intended for being in contact with the content of the container when the container is covered with said stopper, and/or forms at least one part of the stopper intended for being visible and/or accessible from outside the container when the container is covered with said stopper, and/or for forming a leak-tight sealing ring between the stopper and the container. The outer part of the stopper, besides allowing the visual recognition of said stopper, also allows the filtration of air going through the stopper by means of the activated carbon particles. The use of the cork derived product as a leak-tight sealing ring also provides this effect.

Alternatively, it is proposed that the product can be a surface for food use, such as a cutting board, or a part thereof, or a container for food use, or a part thereof.

Alternatively, it is contemplated that said cork derived product is a laminar coating material such as a coating for floors and/or walls which, as a result of the activated carbon, will not give off unwanted substances or odors, or a breathable insulating material that not only does not give off unwanted substances or odors, but will also present a filtration effect for filtering air passing therethrough.

Therefore, the proposed cork composition is proposed for use as a stopper or part of a stopper of a container, such as a surface for food use or a part thereof, a container for food use or a part thereof, a laminar coating, or a breathable insulating material.

It is also contemplated that said product includes different parts, or different parts adhered to one another, wherein the different parts are produced with different concentrations of activated carbon particles, a different particle size distribution of activated carbon particles, and/or a different particle size distribution of cork particles. This difference can alter the properties of each of the parts or can provide said parts with a different darkened color.

Preferably, the activated carbon will be between 1% and 50% of the dry weight of the cork-derived product, preferably between 10% and 40%.

A method of manufacturing the mentioned cork derived product is also contemplated, which method comprises, as is known, the following steps:
mixing granulated and/or microgranulated cork particles with a binder precursor;
compressing and heating the mixture in a mold or in an extruder, causing the polymerization of the binder precursor, transforming it into a binder;

However, the method further comprises the following additional step, which is not known in the state of the art:
mixing activated carbon particles with granulated cork particles before compressing and heating the mixture.

The activated carbon particles can be mixed with the cork particles before, after, or at the same time as they are mixed with the binder precursor.

According to one embodiment, the activated carbon particles will be mixed with the cork particles before adding the binder precursor to the mixture in order to achieve maximum filtration and purification of the cork particles by the activated carbon before adding the binder precursor.

Other features of the invention will become apparent in the following detailed description of an embodiment.

### BRIEF DESCRIPTION OF THE FIGURES

The foregoing and other advantages and features will be better understood based on the following detailed description of an embodiment in reference to the attached drawings which must be interpreted in an illustrative and non-limiting manner. In the figures:

FIG. 1 shows a cork derived product without activated carbon, corresponding to the state of the art, in the form of a flat rectangular sheet;

FIG. 2 shows a cork derived product in the form of a flat rectangular sheet with activated carbon in a first proportion and having a first darkened color depicted with hatching;

FIG. 3 shows a cork derived product in the form of a flat rectangular sheet with activated carbon in a second greater proportion and having a second darker darkened color depicted with a denser hatching;

FIG. 4 shows a cork derived product in the form of a flat rectangular sheet with activated carbon in a third proportion and with the color being darker in the interstices between the cork particles than on the cork particles;

FIG. 5 shows a cork derived product in the form of a flat rectangular sheet with activated carbon in a fourth proportion and which, in addition to the general darkened color, includes activated carbon particles having a size equivalent to the size of the cork particles, for example particles greater than 1 mm;

FIGS. 6 to 9 show four examples of stoppers including the cork derived product, with the first two examples of stoppers being formed entirely by said cork derived product, the third example showing a large-headed stopper only partially formed by said cork derived product, and the fourth example showing a stopper in which the cork derived product only forms a sealing ring.

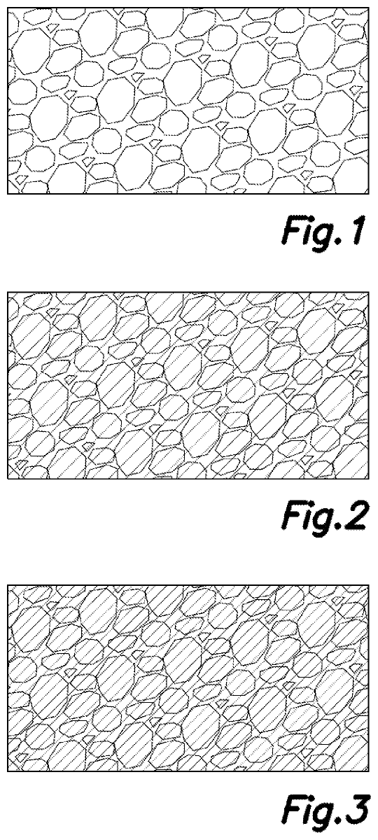

### DETAILED DESCRIPTION OF AN EMBODIMENT

The attached figures show illustrative, non-limiting embodiments of the present invention.

According to a first embodiment of the invention, a stopper for bottles containing wine, cava, champagne, or another beverage, which is formed, at least in part, by a cork derived product formed by a bonded mass of granulated and/or microgranulated cork particles mixed with activated carbon particles, is proposed.

The activated carbon particles contained in the cork derived product can all have a homogenous or heterogeneous particle size distribution. For example, it is contemplated to mix particles equal to or greater than 1 mm with microparticles and/or nanoparticles.

Activated carbon will be present in the product in a sufficient proportion so that the color brightness of the resulting cork derived product is equal to or less than 50%, or even 40%, providing cork derived products with a range of colors ranging from dark brown to black.

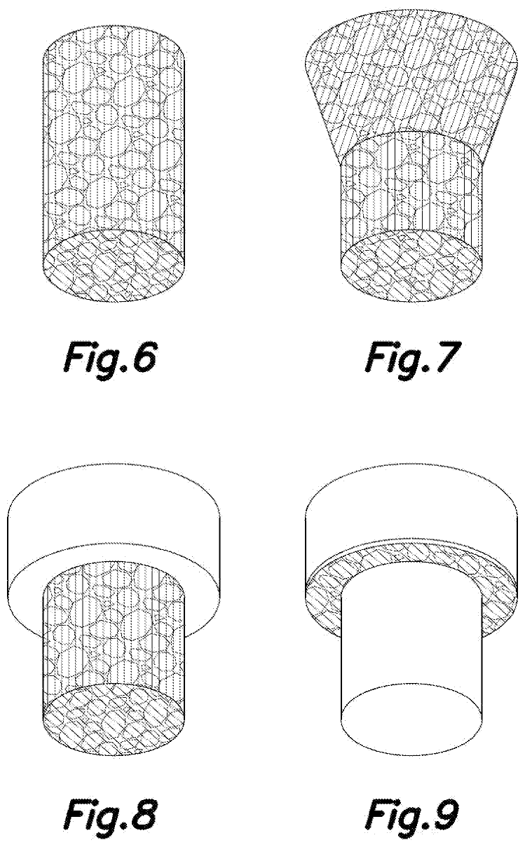

Said stopper can be formed entirely by the mentioned cork derived product, for example, forming a stopper for wine, cava, or champagne such as those schematically shown in FIGS. 6 and 7.

Alternatively, only a part of the stopper will be formed by the proposed cork derived product. For example, FIG. 8 shows a large-headed stopper in which only the part intended for being inserted into the neck of the bottle is formed by the proposed cork derived product, with the head of the stopper being made of another material. Said another material can be, for example, plastic, wood, glass, or even a natural cork derived product or granulated cork bonded without activated carbon, or with a different particle size distribution or proportion of activated carbon.

It is also proposed for the stopper to possibly include the proposed cork derived product with different concentrations of activated carbon in different parts thereof.

FIG. 9 shows another embodiment according to which the stopper only includes the proposed cork derived product in a sealing ring intended for being pressed against the mouth of a container covered by said stopper. Said sealing ring will filter the gas passing therethrough.

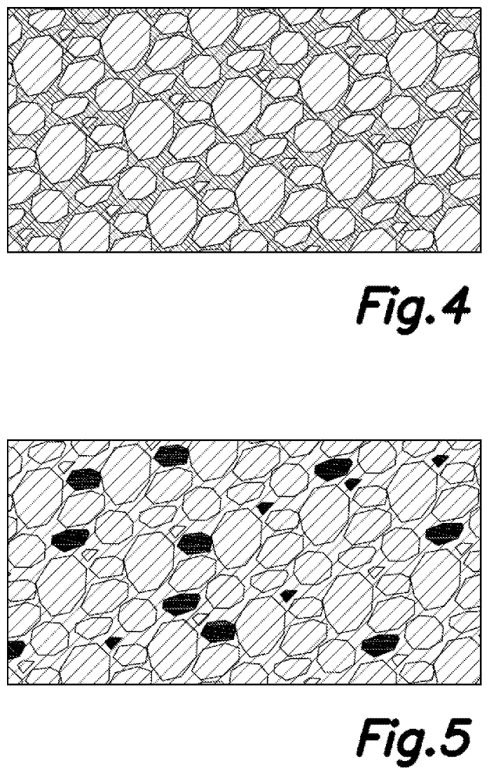

Other uses of the cork derived product are also contemplated. For example, FIGS. 2 to 5 show different flat rectangular sheets of said material which can be used as cutting surfaces for food products, as trays, as a coating for floors, walls, or furniture, or even as a breathable insulating material, among many other possible uses.

Said cork derived product also can have the shape of container, for example a dish, plate, or the like, or be a part thereof.

It will be understood that the different parts forming the invention described in an embodiment can be freely combined with the parts described in other different embodiments although said combination has not been explicitly described, provided that the result of said combination is within the scope of the claims and provided that there is no incompatibility in the combination.

1. A cork derived product formed by a bonded mass of granulated and/or microgranulated cork particles and activated carbon particles mixed with the cork particles;
wherein the cork derived product is selected among a container or a surface for use in contact with food, cosmetic, or perfume products, a container stopper or as a part thereof;
the cork particles and the activated carbon particles are bonded together by a binder; and
the cork derived product includes the activated carbon particles in a proportion between 10% and 40% of the dry weight of the product, giving the cork derived product a darkened color.

2. The cork derived product according to claim 1, wherein the activated carbon particles are or include microparticles and/or nanoparticles, or are particles with a size comprised between 0.5 micra and 5 mm.

3. The cork derived product according to claim 1, wherein the cork particles are particles with a size comprised between 0.2 mm and 10 mm.

4. The cork derived product according to claim 1 wherein the binder is an isocyanate or a polyisocyanate.

5. The cork derived product according to claim 1, wherein the darkened color has a mean color brightness value of at least 10% or at least 15% less than the mean color brightness value of an equivalent product lacking activated carbon.

6. The cork derived product according to claim 1, wherein the darkened color has a mean color brightness value equal to or less than 50% or equal to or less than 40%.

7. The cork derived product according to claim 1, wherein the product includes parts, or parts adhered to one another, with different concentrations of activated carbon particles, with a different particle size distribution of activated carbon particles, and/or with a different particle size distribution of cork particles.

8. (canceled)

9. The cork derived product according to claim 1, wherein the cork derived product is at least one part of the stopper in contact with a hollow interior of the container and/or at least one part of the stopper defining a sealing ring pressing against a mouth of the container.

10. The cork derived product according to claim 1, wherein the cork derived product is a cutting board.

11. A method of manufacturing a cork derived product selected among a container or a surface for use in contact with food, cosmetic, or perfume products, a container stopper or as a part thereof; the method including the steps of:
mixing granulated and/or microgranulated cork particles with a binder precursor;
compressing and heating the mixture in a mold or in an extruder, causing the polymerization of the binder precursor, transforming the binder precursor into a binder;
mixing activated carbon particles with granulated and/or microgranulated cork particles before compressing and heating the mixture, the activated carbon particles being in a proportion between 10% and 40% of the dry weight of the product, giving the cork derived product a darkened color.

12. The method according to claim 10, wherein the activated carbon particles are mixed with the cork particles before or simultaneously with the mixing of cork particles with the binder precursor.

13. The method according to claim 10, wherein the activated carbon particles are mixed with the cork particles after the mixing of cork particles with the binder precursor.
